(19) United States
(12) Patent Application Publication
(10) Pub. No.: US 2007/0254067 A1
(43) Pub. Date: Nov. 1, 2007

(54) Consumer customizable oral care products

(75) Inventor: Thinh Nguyen Ha, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/796,925

(22) Filed: Apr. 30, 2007

Related U.S. Application Data
(60) Provisional application No. 60/796,428, filed on May 1, 2006.

(51) Int. Cl. G06F 17/00; A23C 9/20

(52) U.S. Cl. 426/71

(57) ABSTRACT

Disclosed are oral care products that consumers can directly customize according to their needs and preferences. The consumer selects a base oral care product and one or more customization agents to add to the base product to make a customized product that provides the desired therapeutic and aesthetic benefits and in-use experience. The base oral care product to be customized includes dentifrice, toothpaste, tooth gel, subgingival gel, mouthrinse, mouthspray, tooth whitening gel, denture product, and dental floss or tape. The customization agent comprises a component selected from oral care actives; flavors; sweeteners; materials affecting taste, mouthfeel, smell or other sensation such as essential oils, coolants and warming agents; product aesthetic agents such as colorants, opacifiers, speckles and texture or rheology modifying agents; and combinations thereof.

### CROSS REFERENCE TO RELATED APPLICATIONS

This application claims the benefit of U.S. Provisional Application No. 60/796,428, filed May 1, 2006.

### FIELD OF THE INVENTION

Disclosed are oral care products that consumers can directly customize according to their needs and preferences. The consumer selects a base oral care product and one or more customization agents to add to the base product to make a customized product that provides the desired therapeutic and aesthetic benefits and in-use experience.

### BACKGROUND OF THE INVENTION

The health and appearance of teeth and the oral cavity are among the most important concerns of daily living. Consumers have various needs including prevention of dental plaque and calculus, stain removal, whitening teeth and controlling bad breath.

Dental plaque, calculus and bad breath all involve microbial activity in the oral cavity. Dental plaque is a mixed matrix of bacteria, epithelial cells, leukocytes, macrophages and other oral exudate. Bacteria comprise approximately three-quarters of the plaque matrix. Any given sample of dental plaque could contain as many as 400 different varieties of microorganisms. Dental calculus, or tartar as it is sometimes called, is a deposit which forms on the surfaces of the teeth at the gingival margin. Supragingival calculus appears principally in the areas near the orifices of the salivary ducts; e.g., on the lingual surfaces of the lower anterior teeth and on the buccal surfaces of the upper first and second molars, and on the distal surfaces of the posterior molars. Mature calculus consists of an inorganic portion which is largely calcium phosphate arranged in a hydroxyapatite crystal lattice structure similar to bone, enamel and dentine. An organic portion is also present and consists of desquamated epithelial cells, leukocytes, salivary sediment, food debris and various types of microorganisms. Developing plaque can adhere most easily at relatively irregular surfaces, such as those afforded by calculus. As the mature calculus develops, it becomes visibly white or yellowish in color unless stained or discolored by some extraneous agent. In addition to being unsightly and undesirable from an aesthetic standpoint, the mature calculus deposits are constant sources of irritation of the gingiva.

The failure to retard or stop the proliferation of plaque and calculus is detrimental to oral health. Plaque and calculus formation may lead to dental caries, gingival inflammation, periodontal disease, and ultimately tooth loss. Additionally, calculus and plaque along with behavioral and environmental factors lead to formation of dental stains, significantly affecting the aesthetic appearance of teeth. Behavioral and environmental factors that contribute to teeth staining propensity include regular use of coffee, tea, cola or tobacco products, and also the use of stain promoting oral products.

Thus, for oral care products for daily use such as dentifrice, rinses, and dental floss to provide thorough cleaning and care of the oral cavity, it is necessary to add multiple ingredients working by different mechanisms to provide antimicrobial, antiplaque and anticalculus benefits as well as stain removal, stain control, tooth whitening, control of bad breath and breath freshening. Formulating such products presents many difficulties such as would arise from incompatibility of multiple ingredients. In addition, many different versions of products are required to take into account the differing needs and preferences of consumers, for example, with regard to flavor, appearance, and texture of oral care products. However, due to limitations relating to production capabilities, shipping quantities and shelf space, a manufacturer is typically limited as to the variety of products that can be made available to consumers. Furthermore, there are instances when consumers desire to “create” their own unique product rather than be limited to the choices provided by the manufacturer.

The present invention addresses these problems by providing oral care products that consumers can directly customize for their own needs and preferences. The consumer creates a customized oral care product by adding onto a base product one or more customization agents that boost the efficacy, aesthetic appeal or use experience derived from the oral care product.

### SUMMARY OF THE INVENTION

The present invention is directed to customizable oral care products and compositions and encompasses providing the consumer with

a) a base oral care product, and

b) one or more customization agents comprising a component capable of enhancing or modifying one or more of performance and aesthetic attributes of the base oral care product, wherein the customization agent is physically and chemically compatible with the base oral care product, such that the consumer may combine one or more customization agents with a base oral care product to make a customized oral care product that delivers the consumer selected benefit or combination of benefits, and/or use experience. The base oral care product to be customized includes toothpaste, dentifrice, tooth gel, subgingival gel, mouthrinse, mouthspray, tooth whitening gel, denture product, and dental floss or tape. The customization agent comprises a component selected from oral care actives; flavors; sweeteners; materials affecting taste, mouthfeel, smell or other sensation such as essential oils, coolants and warming agents; product aesthetic agents such as colorants, opacifiers, speckles and texture or rheology modifying agents; and combinations thereof.

### DETAILED DESCRIPTION OF THE INVENTION

While the specification concludes with claims particularly pointing out and distinctly claiming the invention, it is believed that the present invention will be better understood from the following description.

All percentages and ratios used hereinafter are by weight of total composition, unless otherwise indicated. All percentages, ratios, and levels of ingredients referred to herein are based on the actual amount of the ingredient, and do not include solvents, fillers, or other materials with which the ingredient may be combined as a commercially available product, unless otherwise indicated.

All measurements referred to herein are made at 25° C. unless otherwise specified.

Herein, “comprising” means that other steps and other components which do not affect the end result can be added. This term encompasses the terms “consisting of” and “consisting essentially of.”

As used herein, the word “include,” and its variants, are intended to be non-limiting, such that recitation of items in a list is not to the exclusion of other like items that may also be useful in the materials, compositions, devices, and methods of this invention.

As used herein, the words “preferred”, “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

By “oral care composition” is meant a product, which in the ordinary course of usage, is not intentionally swallowed for purposes of systemic administration of particular therapeutic agents, but is rather retained in the oral cavity for a time sufficient to contact substantially all of the dental surfaces and/or oral tissues for purposes of oral activity. The oral care composition of the present invention may be in various forms including dentifrice, toothpaste, tooth gel, subgingival gel, mouthrinse or mouthwash, mouthspray, whitening or bleaching gel, denture product, lozenge, chewable tablet or chewing gum. The oral care composition may also be incorporated onto strips or films for direct application or attachment to oral surfaces.

The term “dentifrice”, as used herein, means paste, gel, or liquid formulations unless otherwise specified. The dentifrice composition may be a single phase composition or may be a combination of two or more separate dentifrice compositions. The dentifrice composition may be in any desired form, such as deep striped, surface striped, multilayered, having the gel surrounding the paste, or any combination thereof. Each dentifrice composition in a dentifrice comprising two or more separate dentifrice compositions may be contained in a physically separated compartment of a dispenser and dispensed side-by-side.

The term “dispenser”, as used herein, means any pump, tube, or container suitable for dispensing compositions such as dentifrices.

The term “teeth”, as used herein, refers to natural teeth as well as artificial teeth or dental prosthesis.

The term “orally acceptable carriers, actives or excipients” includes safe and effective materials and conventional additives used in oral care compositions including but not limited to fluoride ion sources, anti-calculus or anti-tartar agents, buffers, abrasives such as silica, peroxide sources, alkali metal bicarbonate salts, thickening materials, humectants, water, surfactants, titanium dioxide, flavor system, sweetening agents, xylitol, coloring agents, and mixtures thereof.

Active and other ingredients useful herein may be categorized or described herein by their cosmetic and/or therapeutic benefit or their postulated mode of action or function. However, it is to be understood that the active and other ingredients useful herein can, in some instances, provide more than one cosmetic and/or therapeutic benefit or function or operate via more than one mode of action. Therefore, classifications herein are made for the sake of convenience and are not intended to limit an ingredient to the particularly stated application or applications listed.

The phrase “use experience” includes the entirety of consumer experiences during selection of oral care product(s), making and customization of the oral care product, dispensing and use, in particular the sensations experienced during and after use of the product including without limitation, taste, smell, cooling, warming, effervescence, refreshing, clean feeling, texture, etc.

In one embodiment of the present invention, a base oral care rinse and an array of customizing agents for mixing with the base rinse are provided. The base rinse will typically comprise a solvent (e.g., water, alcohol, glycerin, propylene glycol, polyethylene glycol and mixtures thereof) and a surfactant (e.g., Tween 80, Poloxamer, sodium lauryl sulfate, etc.). Preferably, the base rinse also comprises an oral care active (e.g., antimicrobial agent, breath freshening agent, deodorizing agent) and flavoring agent and sweetener such that the base rinse may be used as is without further customization. The customizing agent may be provided for example as tablets, beads, beadlets, capsules, powder, liquid, paste or gel. Further the customizing agent may be packaged and sold as individual packets, sachets, vials or disposable cups suitable for metering an appropriate amount of a base mouthrinse for a single use. Or a plurality of customizing agents may be packaged to correspond to the number of recommended doses or uses for the base product. For example, a blister pack of 10 capsules of customizing agent may be packaged to complement a 250 ml base product that is recommended for 10 uses at 25 ml per use. The customizing agent may be added to change the visual appearance of the product (color, translucence, sparkles); flavor type or intensity, in-use experience and sensation (e.g., cooling, warming, burning, tingling, etc); texture (thin, thick, coating); and to enhance therapeutic or other benefits (e.g., kills bad breath germs, helps removes plaque, whitening, stain prevention, anti-erosion).

Specific combinations will be recommended on the packaging or use instructions for the base rinse and/or the customizing agent. Consumers can create their own combinations and share them via a website, email, telephone or text messaging.

The previously described embodiment of the present invention provides many advantages, including providing the consumer with flexibility and variety. For example, a variety of flavors may be provided in unit form such as individual beads or capsules. This would circumvent the need for providing an unlimited variety of pre-flavored rinses. The consumer can be provided with an unflavored or mildly flavored base rinse along with a variety of flavor beads or capsules. The flavor customization agent may optionally include additional sensory materials such as coolants or warming agents to further enhance the sensory benefits from the customized product or the sensory materials may also be provided as customization agents. Such an array of flavor/sensory material customization agents drastically reduces the production costs (only one or two base rinse products, unflavored or mildly flavored, need be manufactured), shipping costs (the flavor/sensory material unit products are significantly less bulky and weigh less than a full rinse product), and shelf space (space needs to be provided for the base rinse product and the customizing agent unit products which take up significantly less space than a variety of pre-flavored rinses).

A consumer can choose a desired flavor/sensory material from a “variety pack” and can adjust the flavor or sensory intensity for example, by the number of beads or capsules to be added. The consumer can further combine different flavorings to produce a unique flavor combination. In one embodiment, the flavor and optionally sweetener and sensory material may be presolubilized in liquid, paste or gel form and encapsulated. The capsule shell is preferably made of a highly soluble material, which would allow for rapid dissolution when added to the base rinse. Encapsulation also provides oxidation and degradation protection for the flavor and sweetener materials contained in the capsule core. The capsules are easily portable and can be packaged individually or contained in an easy to use dispenser such as a blister pack. The capsules may be color coded to indicate the flavor type, e.g., green for mint, red for cinnamon, pink for strawberry, yellow for lemon, orange for citrus, light caramel or clear for vanilla, etc.

The flavor customizing agent is particularly useful to custom flavor a base mouthrinse that contains agents that have unpleasant taste and/or are incompatible with flavoring agents, such as peroxide. It has long been recognized that hydrogen peroxide and other peroxygen-containing agents are effective in curative and/or prophylactic treatments with respect to caries, dental plaque, gingivitis, periodontitis, mouth odor, tooth stains, recurrent aphthous ulcers, denture irritations, orthodontic appliance lesions, postextraction and postperiodontal surgery, traumatic oral lesions and mucosal infections, herpetic stomatitis and the like. Peroxide-containing agents in the oral cavity exert a chemomechanical action generating thousands of tiny oxygen bubbles produced by interaction with tissue and salivary enzymes. The swishing action of a mouthrinse enhances this inherent chemomechanical action. Such action has been recommended for delivery of other agents into infected gingival crevices. Peroxide mouthrinses prevent colonization and multiplication of anaerobic bacteria known to be associated with periodontal disease. However, hydrogen peroxide and other peroxide releasing compounds in such oral compositions interact with other common excipients therein and tend to be unstable in storage, continuously losing the capacity to release active or nascent oxygen over relatively short periods of time, and tend to diminish or destroy the desired function of such excipients. Among such excipients are flavors, sensory materials and coloring agents added to enhance the acceptability of the mouthrinse to those in need of an oral peroxidizing treatment.

Thus in one embodiment of the present invention, a base peroxide rinse is provided, which may be customized by the consumer with one or more of flavor, taste, sensory or color customizing agents. Preferably the customizing agents are mixed with the base peroxide rinse just prior to use, thereby avoiding any component degradation and ensuring a product with a pleasant appearance, taste and sensory experience and importantly, efficacy from the peroxide component.

In other embodiments, flavor, sensory or color customizing agents are used with whitening gels which normally contain a high level of peroxide and typically none of the ingredients such as flavors or colors that are incompatible with the peroxide. In particular a flavor customizing agent added to the whitening gel prior to use would make the whitening treatment more pleasant for the consumer.

Alternatively, the peroxide or other bleaching agent can be a customizing agent itself or optionally with a flavor customizing agent and combined with a non-peroxide base mouthrinse to create a custom flavored whitening or bleaching rinse. The consumer may choose to use such a whitening rinse each occasion or less frequently as desired. For example, the whitening rinse may be part of a regimen that includes a night time whitening treatment.

In further embodiments of the present invention, a peroxide customizing agent is combined with a base dentifrice, denture cleanser or dental floss/tape to enhance the efficacy of these products and/or to whiten teeth. The peroxide whitening agent may be provided as a stabilized gel in individual capsules or sachets or packaged for example, in squeeze tubes for dispensing as a strip or ribbon onto a toothbrush in combination with a strip of base dentifrice. A peroxide capsule may be combined with a denture cleansing tablet to make a cleansing, whitening bath to soak dentures. A dental/floss or tape may be coated with the peroxide gel prior to use to deliver peroxide to interdental spaces and gingival tissue.

In addition to flavors, sensory materials and peroxide as customizing agents, the present invention contemplates the use of other oral care actives and excipients such as fluoride ion sources, anti-caries agents, anti-calculus or anti-tartar agents, desensitizing agents, abrasive polishing materials, pH adjusting agents, thickening materials, and humectants.

The customizing agent will comprise an active at a level which upon mixing with a base product would deliver an effective amount to provide the benefit sought by the user without detriment to the oral surface to which the composition is applied. Examples of benefits these actives address include, but, are not limited to, appearance and structural changes to teeth including whitening, stain bleaching, stain removal, prevention and treatment of plaque, tartar, caries, cavities and dentinal sensitivity; treatment of oral cavity conditions such as inflamed and/or bleeding gums, mucosal wounds, lesions, ulcers, aphthous ulcers, cold sores, and tooth abscesses; and elimination of mouth malodor resulting from the conditions above and other causes such as microbial proliferation.

Suitable oral care actives include materials that are generally considered safe for use in the oral cavity and that provide changes to the overall appearance and/or health of the oral cavity. The level of oral care active in the customized compositions of the present invention may range from about 0.01% to about 50%, depending upon the type of active and the condition being treated. In some embodiments, the level of active may be from about 0.1% to about 20%, or from about 0.5% to about 10%, or from about 1% to about 7%, by weight of the composition.

The following is a non-limiting list of oral care actives that may be used as customizing agents according to the present invention.

1. Teeth Whitening Actives

The actives suitable for whitening are selected from the group consisting of the peroxides, metal chlorites, perborates, percarbonates, peroxyacids, persulfates, and combinations thereof. Suitable peroxide compounds include hydrogen peroxide, urea peroxide, calcium peroxide, and mixtures thereof. Suitable metal chlorites include calcium chlorite, barium chlorite, magnesium chlorite, lithium chlorite, sodium chlorite, and potassium chlorite. Additional whitening actives may be hypochlorite and chlorine dioxide. A preferred percarbonate is sodium percarbonate. Preferred persulfates are oxones.

2. Anti-Tartar Agents

Anti-tartar agents known for use in dental care products include phosphates. Phosphates include pyrophosphates, polyphosphates (e.g., tripolyphosphate; hexametaphosphate), polyphosphonates and mixtures thereof. Pyrophosphates are among the best known for use in dental care products. Pyrophosphate and polyphosphate ions are delivered to the teeth using pyrophosphate or polyphosphate salts. The pyrophosphate salts useful in the present compositions include the dialkali metal pyrophosphate salts, tetra-alkali metal pyrophosphate salts, and mixtures thereof. Disodium dihydrogen pyrophosphate (Na₂H₂P₂O₇), tetrasodium pyrophosphate (Na₄P₂O₇), and tetrapotassium pyrophosphate (K₄P₂O₇) in their unhydrated as well as hydrated forms are the preferred species. While any of the above mentioned pyrophosphate salts may be used, the tetrasodium and tetrapotassium pyrophosphate salts are preferred. Sodium polyphosphate and triethanolamine polyphosphates, for example, are also useful.

The pyrophosphate salts are described in more detail in Kirk & Othmer, Encyclopedia of Chemical Technology, Third Edition, Volume 17, Wiley-Interscience Publishers (1982) and in U.S. Pat. No. 4,590,066 issued May 20, 1986. Linear molecularly dehydrated polyphosphate salts for use as calculus inhibitor are disclosed in U.K. Patent Application GB 2,200,551, Gaffar, Nabi and Jannone, filed Jan. 27, 1988, published Aug. 10, 1988; and in U.S. Pat. No. 4,627,977, issued Dec. 9, 1986, to Gaffar et al. Included among the salts is sodium tripolyphosphate (STPP). Other references disclosing STPP include U.S. Pat. No. 4,923,684, May 8, 1990 to Ibrahim et al. and U.S. Pat. Nos. 5,096,701 issued Mar. 17, 1992 and 5,176,900 issued Jan. 5, 1993 both to White et al. Commonly-assigned U.S. Pat. Nos. 5,939,052; 6,350,436; 6,667,027 and 6,713,049 describe stable oral formulations containing linear condensed polyphosphates in combination with a fluoride source. Detailed studies of the therapeutic and cosmetic benefits of these formulations have revealed surprising levels of fluoride anticaries efficacy, along with improved efficacy in calculus and stain prevention.

Other anticalculus agents that may be used in place of or in combination with the pyrophosphate or polyphosphate salts include polycarboxylates such as those disclosed in U.S. Pat. No. 3,429,963 issued Feb. 25, 1969 and U.S. Pat. No. 4,304,766 issued Dec. 8, 1981; and U.S. Pat. No. 4,661,341 issued Apr. 28, 1987; polyepoxysuccinates such as those disclosed in U.S. Pat. No. 4,846,650 issued Jul. 11, 1989; ethylenediaminetetraacetic acid as disclosed in British Patent No. 490,384 dated Feb. 15, 1937; nitrilotriacetic acid and related compounds as disclosed in U.S. Pat. No. 3,678,154 issued Jul. 18, 1972; polyphosphonates as disclosed in U.S. Pat. No. 3,737,533 issued Jun. 5, 1973, U.S. Pat. No. 3,988,443 issued Oct. 26, 1976 and U.S. Pat. No. 4,877,603 issued Oct. 31, 1989.

Specific examples of anticalculus agents include such known materials as synthetic anionic polymers including polyacrylates and copolymers of maleic anhydride or acid and methyl vinyl ether (e.g., Gantrez), as described, for example, in U.S. Pat. No. 4,627,977; as well as, e.g., polyamino propane sulfonic acid (AMPS), zinc citrate trihydrate, diphosphonates (e.g., EHDP; AHP), polypeptides (such as polyaspartic and polyglutamic acids), and polyphosphorylated inositol compounds such as phytic acid and its salts.

3. Fluoride Ion Source

Fluoride ion sources are well known for use in oral care compositions as anticaries agents. Fluoride ions are contained in a number of oral care compositions for this purpose, particularly toothpastes. Patents disclosing such toothpastes include U.S. Pat. Nos. 3,538,230, Nov. 3, 1970; 3,689,637, Sep. 5, 1972; 3,711,604, Jan. 16, 1973; 3,911,104, Oct. 7, 1975; 3,935,306, Jan. 27, 1976; and 4,040,858, Aug. 9, 1977.

Application of fluoride ions to dental enamel serves to protect teeth against decay. A wide variety of fluoride ion-yielding materials can be employed as sources of soluble fluoride in the instant compositions. Examples of suitable fluoride ion-yielding materials are disclosed in U.S. Pat. No. 3,535,421, issued Oct. 20, 1970 and in U.S. Pat. No. 3,678,154, issued Jul. 18, 1972, such as sodium fluoride, potassium fluoride, stannous fluoride and ammonium fluoride. In one embodiment, customized compositions provide from about 50 ppm to 10,000 ppm; in another embodiment from about 100 to 3000 ppm, of fluoride ions in the compositions that contact dental surfaces.

A fluoride customizing agent would be useful, for example, to add to a base mouthrinse which is typically not fluoridated. A multi-user household would then have the option of obtaining a single base mouthrinse product, which may be fluoridated as needed for use by those in need of fluoride treatment, for example, children. A preferred fluoride customizing agent is stannous fluoride which would provide fluoride as well as stannous ions, which also provide additional benefits including antimicrobial and anti-sensitivity. Delivering stannous fluoride as a customizing agent solves the formulation difficulties associated with stannous fluoride such as instability of stannous in aqueous systems, susceptibility to oxidation and loss of activity due to interaction with common excipients in oral care products.

4. Anti-Microbial Agents

Anti-microbial agents include, but are not limited to, 5-chloro-2-(2,4-dichlorophenoxy)-phenol (triclosan) described in The Merck Index, 11th ed. (1989), pp. 1529 (entry no. 9573) in U.S. Pat. No. 3,506,720, and in European Patent Application No. 0,251,591, published Jan. 7, 1988; phthalic acid and its salts including, but not limited to those disclosed in U.S. Pat. No. 4,994,262, Feb. 19, 1991, such as magnesium monopotassium phthalate, chlorhexidine (Merck Index, no. 2090), alexidine (Merck Index, no. 222; hexetidine (Merck Index, no. 4624); sanguinarine (Merck Index, no. 8320); benzalkonium chloride (Merck Index, no. 1066); salicylanilide (Merck Index, no. 8299); domiphen bromide (Merck Index, no. 3411); cetylpyridinium chloride (CPC) (Merck Index, no. 2024); tetradecylpyridinium chloride (TPC); N-tetradecyl-4-ethylpyridinium chloride (TDEPC); octenidine; delmopinol, octapinol, and other piperidino derivatives; nicin preparations; zinc/stannous/copper ion agents; antibiotics such as augmentin, amoxicillin, tetracycline, doxycycline, minocycline, metronidazole and analogs and salts of the above; essential oils including thymol, geraniol, carvacrol, citral, hinokitiol, eucalyptol, catechol (particularly 4-allyl catechol), methyl salicylate and mixtures thereof; hydrogen peroxide; and metal salts of chlorite.

Oral care products can be customized with anti-microbial agents to boost efficacy in treating oral cavity conditions such as gingivitis, periodontal disease, inflamed and/or bleeding gums, mucosal wounds, lesions, ulcers, aphthous ulcers, cold sores, tooth abscesses, and mouth malodor resulting from the conditions above and other causes such as microbial proliferation.

5. Anti-Inflammatory Agents

Anti-inflammatory agents can also be used as customizing agent to boost efficacy of oral care products to treat conditions that involve inflammation, particularly gingivitis and periodontal disease. Such agents may include, but are not limited to, non-steroidal anti-inflammatory agents or NSAIDs such as ketorolac, flurbiprofen, ibuprofen, naproxen, indomethacin, aspirin, ketoprofen, piroxicam and meclofenamic acid. Use of NSAIDs such as ketorolac for preventing and, or treating primary and reoccurring squamous cell carcinoma of the oral cavity or oropharynx is disclosed in U.S. Pat. No. 5,626,838, issued May 6, 1997.

6. Nutrients

Nutrients may improve the condition of the oral cavity and can be used as a customizing agent to boost the efficacy of base oral care compositions. Nutrients include minerals, vitamins, oral nutritional supplements, enteral nutritional supplements, and mixtures thereof.

Minerals that can be included with the compositions of the present invention include calcium, phosphorus, fluoride, zinc, manganese, potassium and mixtures thereof. These minerals are disclosed in Drug Facts and Comparisons (loose leaf drug information service), Wolters Kluer Company, St. Louis, Mo., ©1997, pp 10-17.

Vitamins can be included with minerals or used separately. Vitamins include Vitamins C and D, thiamine, riboflavin and riboflavin phosphate, calcium pantothenate, niacin, folic acid, nicotinamide, pyridoxine, cyanocobalamin, para-aminobenzoic acid, bioflavonoids, and mixtures thereof. Such vitamins are disclosed in Drug Facts and Comparisons, pp. 3-10.

Oral nutritional supplements include amino acids, lipotropics, fish oil, and mixtures thereof, as disclosed in Drug Facts and Comparisons, pp. 54-54e. Amino acids include, but, are not limited to L-Tryptophan, L-Lysine, Methionine, Threonine, Levocarnitine or L-carnitine and mixtures thereof. Lipotropics include, but, are not limited to choline, inositol, betaine, linoleic acid, linolenic acid, and mixtures thereof. Fish oil contains large amounts of Omega-3 (N-3) polyunsaturated fatty acids, eicosapentaenoic acid and docosahexaenoic acid.

Enteral nutritional supplements include, but, are not limited to protein products, glucose polymers, corn oil, safflower oil, medium chain triglycerides as disclosed in Drug Facts and Comparisons, pp. 55-57.

7. Mouth and Throat Agents

Other materials that can be used with the present invention include commonly known mouth and throat agents, including but not limited to anti-fungal, antibiotic and analgesic agents. Such agents are disclosed in Drug Facts and Comparisons, pp. 520b-527.

8. Antioxidants

Antioxidants may also be used as additional active for customizing oral care compositions. Antioxidants are disclosed in texts such as Cadenas and Packer, The Handbook of Antioxidants, ©1996 by Marcel Dekker, Inc. Antioxidants that may used as customizing agent include, but are not limited to Vitamin E, ascorbic acid, uric acid, carotenoids, Vitamin A, flavonoids and polyphenols, herbal antioxidants, melatonin, aminoindoles, lipoic acids and mixtures thereof.

9. H-2 Antagonists

Histamine-2 (H-2 or H2) receptor antagonist compounds (H-2 antagonists) may be used as customizing agents for oral care compositions. As used herein, selective H-2 antagonists are compounds that block H-2 receptors, but do not have meaningful activity in blocking histamine-1 (H-1 or H1) receptors. Selective H-2 antagonists stimulate the contraction of smooth muscle from various organs, such as the gut and bronchi; this effect can be suppressed by low concentrations of mepyramine—a typical antihistaminic drug. The pharmacological receptors involved in these mepyramine-sensitive histamine responses have been defined as H-1 receptors (Brit. J. Pharmacol Chemother., Vol. 27 (1966), p. 427). Histamine also stimulates the secretion of acid by the stomach (Proc. Soc. Exp. Biol. Med., Vol. 48 (1941), p. 65), increases the heart rate (J. Pharmacol., Vol. 130 (1960), p. 450), and inhibits contractions in the rat uterus (Brit. J. Pharmacol. Chemother., Vol. 1 (1946), p. 278); these actions cannot be antagonized by mepyramine and related drugs. The H-2 antagonists useful herein are those that blockade the receptors involved in mepyramine-insensitive, non-H-1 (H-2), histamine responses, and do not blockade the receptors involved in mepyramine-sensitive histamine responses.

Selective H-2 antagonists are those compounds found to be H-2 antagonists through their performance in classical preclinical screening tests for H-2 antagonist function. Selective H-2 antagonists are identified as compounds which can be demonstrated to function as competitive or non-competitive inhibitors of histamine-mediated effects in those screening models specifically dependent upon H-2 receptor function, but to lack significant histamine antagonist activity in those screening models dependent upon H-1 receptor function. Specifically, this includes compounds that would be classified as described by J. W. Black, et al., “Definition and Antagonism of Histamine H2-Receptors”, Nature, Vol. 236 (Apr. 21, 1972), pp. 385-390, as H-2 antagonists if assessed as described by Black through testing with the guinea pig spontaneously beating right atria in vitro assay and the rat gastric acid secretion in vivo assay, but shown to lack in significant H-1 antagonist activity relative to H-2 antagonist activity, if assessed as described by Black with either the guinea pig ileum contraction in vitro assay or the rat stomach muscle contraction in vivo assay. Preferably selective H-2 antagonists demonstrate no significant H-1 activity at reasonable dosage levels in the above H-1 assays. Typical reasonable dosage level is the lowest dosage level at which 90% inhibition of histamine, preferably 99% inhibition of histamine, is achieved in the above H-2 assays.

Selective H-2 antagonists include compounds meeting the above criteria which are disclosed in U.S. Pat. Nos. 5,294,433 and 5,364,616, assigned to Procter & Gamble, wherein the selective H-2 antagonist is selected from the group consisting of cimetidine, etintidine, ranitidine, ICIA-5165, tiotidine, ORF-17578, lupitidine, donetidine, famotidine, roxatidine, pifatidine, lamtidine, BL-6548, BMY-25271, zaltidine, nizatidine, mifentidine, BMY-25368 (SKF-94482), BL-6341A, ICI-162846, ramixotidine, Wy-45727, SR-58042, BMY-25405, loxtidine, DA-4634, bisfentidine, sufotidine, ebrotidine, HE-30-256, D-16637, FRG-8813, FRG-8701, impromidine, L-643728, and HB-408. Particularly preferred is cimetidine (SKF-92334), N-cyano-N′-methyl-N″-(2-(((5-methyl-1H-imidazol-4-yl)methyl)thio)ethyl)guanidine:

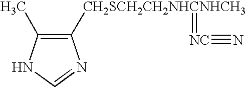

Cimetidine is also disclosed in The Merck Index, 11th edition (1989), p. 354 (entry no. 2279), and Physicians' Desk Reference, 46th edition (1992), p. 2228. Related preferred H-2 antagonists include burimamide and metiamide.

10. Analgesic Actives

Anti-pain or desensitizing agents can also be used as customizing agents. Such agents may include, but are not limited to, strontium chloride, potassium nitrate, natural herbs such as gall nut, Asarum, Cubebin, Galanga, scutellaria, Liangmianzhen, Baizhi, etc.

11. Anti-Viral Actives

Antiviral actives useful as customizing agents include any known actives that are routinely use to treat viral infections. Such anti-viral actives are disclosed in Drug Facts and Comparisons, pp. 402(a)-407(z). Specific examples include anti-viral actives disclosed in U.S. Pat. No. 5,747,070, issued May 5, 1998, including stannous salts. Stannous salts and other anti-viral actives are described in detail in Kirk & Othmer, Encyclopedia of Chemical Technology, Third Edition, Volume 23, Wiley-Interscience Publishers (1982), pp. 42-71. The stannous salts that may be used in the present invention would include organic stannous carboxylates such as stannous gluconate, stannous tartrate, stannous malonate, stannous citrate and stannous acetate and inorganic stannous halides such as stannous fluoride, stannous chloride, stannous chloride dihydrate, stannous bromide, and stannous iodide among others.

12. Enzymes

An individual or combination of several compatible enzymes can also be included as customizing agents. Enzymes are biological catalysts of chemical reactions in living systems. Enzymes combine with the substrates on which they act forming an intermediate enzyme-substrate complex. This complex is then converted to a reaction product and a liberated enzyme which continues its specific enzymatic function.

Enzymes provide several benefits when used in the oral cavity. Proteases break down salivary proteins which are absorbed onto the tooth surface and form the pellicle; the first layer of plaque. Proteases along with lipases destroy bacteria by lysing proteins and lipids which form the structural component of bacterial cell walls and membranes. Dextranases break down the organic skeletal structure produced by bacteria that forms a matrix for bacterial adhesion. Proteases and amylases, not only prevent plaque formation, but also prevent the development of calculus by breaking-up the carbohydrate-protein complex that binds calcium, preventing mineralization.

Enzymes useful in the present invention include any of the commercially available proteases, glucanohydrolases, endoglycosidases, amylases, mutanases, lipases and mucinases or compatible mixtures thereof. Preferred are the proteases, dextranases, endoglycosidases and mutanases, most preferred being papain, endoglycosidase or a mixture of dextranase and mutanase.

### Other Customizing Agents

In addition to oral care actives, excipients such as pH adjusting agents may be used as customizing agents. For example, a base peroxide product which has an acidic pH to stabilize the peroxide may be customized prior to use with an alkaline pH adjusting agent to raise the pH of the composition and improve the bleaching performance of the composition.

Another customizing agent may be an abrasive polishing agent to combine with a non-abrasive product or to increase polishing effectiveness for example, of regular toothpaste products. For example, silicas that are incompatible with toothpaste components such as fluoride or cationic materials may be added to a base toothpaste as a customizing agent. Particularly useful would be abrasive silicas with high polishing effects but having acceptable abrasivity. Examples of such high polishing silicas are described in commonly assigned U.S. Pat. No. 6,740,311, such as Zeodent 109 supplied by J. M. Huber.

In another embodiment, the customization agent comprises a thickening or gelling agent in order to make a viscous gel suitable for painting onto teeth or mucosal tissues for prolonged delivery of oral care actives such as antimicrobials. For example, a base rinse product containing cetyl pyridinium chloride (CPC) antimicrobial may be modified with a customization agent containing thickening and film-forming agents to provide a gel having enhanced substantivity to oral tissue and thus allowing prolonged oral tissue contact times and exposure to the antimicrobial. Such CPC gel may be applied to gingival surfaces, particularly the gingival margin and left on, e.g., for overnight treatment. The application is such that the gel is applied to the oral cavity before sleeping and is not intentionally removed from the oral cavity by way of rinsing or mechanical brushing or other such like means before sleeping. It has been found that this method is advantageous in combating the degeneration of the oral cavity overnight and reducing morning mouth malodor.

Suitable thickening agents useful in the present invention include polysaccharide thickeners, clays, cross-linked poly-acrylates, co-polymers, polyethylene glycols and derivatives, protein thickeners and mixtures thereof. The customization agent comprises an amount of thickening agent sufficient to provide a gel with appropriate viscosity, such that the gel, when placed on an applicator or finger, does not run off or prove too runny to use effectively. The gel viscosity is typically from about 0.1 Pa.s to about 300 Pa.s, preferably from about 30 Pa.s to about 200 Pa.s, and more preferably from about 80 Pa.s to about 120 Pa.s at a shear rate of 1 s⁻¹. The level of thickener to form gels having appropriate viscosity typically ranges from about 0.1% to about 15% by weight of the final composition.

Alternatively, the thickened or gelled composition may be incorporated onto strips or films for direct application or attachment to oral surfaces. Examples of suitable strips which are flexible and conformable are described for example in commonly assigned U.S. Pat. Nos. 5,879,691; 5,891,453; 5,894,017; 5,989,569; 6,045,811; 6,096,328; and 6,136,297. A film containing the composition quickly forms on the surface to which the composition has been applied. Prolonged delivery of the oral care substance is made possible as the oral care substance is released from the film over time. Then, any residual product may be easily removed by wiping, brushing or rinsing the oral surface after a desired period of time has elapsed, or in the normal course of tooth brushing or other oral care activities.

In yet another embodiment, various components of oral care products may be provided separately as customization agents and two or more are combined to make a customized product. In this embodiment, the first customization agent becomes the base product that is customized with a second or additional customization agent(s). For example, a fluoride customization agent may be combined with a flavor agent to make a basic non-abrasive fluoride dentifrice. This may be desirable for use by persons with sensitivity to abrasives, a usual component of currently marketed dentifrice products. If desired, an abrasive customization agent may be added to provide polishing and additional cleaning. Or a peroxide customization agent may be added to make a whitening dentifrice. In another example, an antimicrobial customization agent and a flavor/coolant customization agent may be mixed with water to make a refreshing antiseptic rinse.

In other embodiments, kits are provided to consumers that further simplify direct customization of oral care products. The kits may comprise:

a) one or more base oral care products including, without limitation, dentifrice, tooth gel, mouthrinse, whitening gel or strips, dental floss or tape, interproximal device and denture product;
b) one or more customization agents that are physically and chemically compatible with the base oral care product and capable of enhancing or modifying performance and aesthetic attributes of the base oral care product; and
c) instructions for selecting the particular customization agent(s) to combine with the base oral care product to make a customized product that delivers the oral care benefit(s) and/or use experience(s) desired by the consumer.

The kits would preferably include charts or guides to assist consumers in making appropriate selections. For example, a chart matching each benefit/activity or sensory attribute to the base product and customization agent(s) to achieve each benefit or attribute may be provided.

### Method of Use

In practicing the present invention, the user selects a base product and one or more customization agents to add to the base product to make a ready-to-use oral care product customized according to the needs and preferences of the user. The user then need only apply the customized product that contains the oral care substance or substances necessary in order to obtain the desired effect or use experience, e.g., whitening, breath freshening, caries prevention, pain relief, desensitizing, gum health, tartar control, etc. to teeth and other surfaces of the oral cavity in the areas desired. The mode of application is of course dependent on the final form of the composition, for example, by rinsing with a mouthrinse, directly applying a whitening or antimicrobial gel with or without a device to oral surfaces, or applying a dentifrice or a tooth gel by brushing teeth and other oral surfaces with a toothbrush.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1

### Mouthrinses and Flavor Customization Agents

Mouthrinse formulations 1A-1D are customized by adding from about 0.25 to about 10 gm flavor customization agent 1E-1G per 100 ml of base mouthrinse. The customization agent may be supplied as unit doses containing from about 0.0625 gm to about 2.5 gm flavor agent for customizing one dose of mouthrinse of from about 10 ml to about 30 ml.

| | Mouthrinse Base Formulas | | | |
|---|---|---|---|---|
| | Base 1A | Base 1B | Base 1C | Base 1D |
| Ingredient | % by wt | % by wt | % by wt | % by wt |
| Alcohol | 15.0 | | | |
| Cetylpyridinium chloride | 0.0450 | | 0.100 | 0.050 |
| 35% H₂O₂ Solution | | 4.500 | 4.500 | |
| Zinc lactate | | | | 0.250 |
| Glass H Polyphosphate | | 2.00 | | |
| Glycerin | 7.5000 | 11.00 | 20.000 | 13.000 |
| Propylene Glycol | | 3.000 | 4.000 | |
| Polysorbate 80 | 0.20 | | | |
| Poloxamer 407 | | 0.750 | 0.100 | 0.025 |
| Sodium Benzoate | 0.0537 | | | |
| Benzoic Acid | 0.0045 | | | |
| Sodium Citrate | | 0.210 | | |
| Citric Acid | | 0.050 | | |
| Water | QS | QS | QS | QS |
| | Flavor Customization Agents | | | |
| | 1E | 1F | 1G | 1H |
| Ingredient | % by wt | % by wt | % by wt | % by wt |
| Peppermint Flavor Oil | 25.0 | 4.0 | 25.0 | 20.0 |
| Menthol | | | 6.0 | 15.00 |
| WS-3 Coolant | | | | 7.50 |
| WS-23 coolant | | | 6.0 | 3.50 |
| Alcohol | 10.0 | 10.0 | 12.0 | 12.00 |
| Blue #1 color solution | 10.0 | | 7.0 | 10.00 |
| Saccharin | 12.0 | 12.0 | 12.0 | 20.00 |
| Cinnamon Flavor | | 21.0 | | |
| Red #33 Color | | 3.0 | | |
| Red # 40 Color | | 7.0 | 3.0 | |
| Water | QS | QS | QS | QS |

### Example 2

### Customized Dentifrice

A dentifrice base formula is customized by adding a peroxide and/or abrasive customization agent for enhanced whitening and/or polishing effects. The customization agents may be supplied in unit doses ranging from about 0.01 gm to 1 gm for addition to a unit dose of about 0.5 gm to about 2 gm of base dentifrice. The table below illustrates the composition of the customized dentifrice after addition of specified amounts of customization agent to 1 gm of base dentifrice.

| | Dentifrice Base Formula | | | | | |
|---|---|---|---|---|---|---|
| | | 1 gm | 1 gm | 1 gm | 1 gm | 1 gm |
| | | Base + 0.01 gm | Base + 0.05 gm | Base + 0.1 gm | Base + 0.2 gm | Base + 0.5 gm |
| | | Additive | Additive | Additive | Additive | Additive |
| Ingredient | % by wt | wt. in gm | wt. in gm | wt. in gm | wt. in gm | wt. in gm |
| Sodium Fluoride, USP | 0.243 | 0.00243 | 0.00243 | 0.00243 | 0.00243 | 0.00243 |
| Sorbitol Solution, USP | 65.508 | 0.65508 | 0.65508 | 0.65508 | 0.65 | |
| 508 | 0.65508 | | | | | |
| Water, USP | 11.355 | 0.11355 | 0.11355 | 0.11355 | 0.11355 | 0.11355 |
| Silica, Dental Type, NF | 15.000 | 0.15 | 0.15 | 0.15 | 0.15 | 0.15 |
| Zeodent 119 | | | | | | |
| CMC 7M8SF | 0.750 | 0.0075 | 0.0075 | 0.0075 | 0.0075 | 0.0075 |
| Carbomer 956 | 0.300 | 0.003 | 0.003 | 0.003 | 0.003 | 0.003 |
| Sodium Lauryl Sulfate | 4.000 | 0.04 | 0.04 | 0.04 | 0.04 | 0.04 |
| Flavor | 0.500 | 0.005 | 0.005 | 0.005 | 0.005 | 0.005 |
| Saccharin SodiumUSP | 0.250 | 0.0025 | 0.0025 | 0.0025 | 0.0025 | 0.0025 |
| Titanium Dioxide (TiO₂) | 0.525 | 0.00525 | 0.00525 | 0.00525 | 0.00525 | 0.00525 |
| FD&C Blue #1 Soln | 0.050 | 0.0005 | 0.0005 | 0.0005 | 0.0005 | 0.0005 |
| Na Phosphate,Tribasic | 1.100 | 0.011 | 0.011 | 0.011 | 0.011 | 0.011 |
| Na Orthophosphate | 0.419 | 0.00419 | 0.00419 | 0.00419 | 0.00419 | 0.00419 |
| Peroxide Customization | | | | | | |
| Agent | | | | | | |
| Carbomer 956 | 2.00 | 0.0002 | 0.001 | 0.002 | 0.004 | 0.01 |
| NaOH (50% sol'n) | 0.75 | 0.000075 | 0.000375 | 0.00075 | 0.0015 | 0.00375 |
| H₂O₂ (35% sol'n) | 25.00 | 0.0025 | 0.0125 | 0.025 | 0.05 | 0.125 |
| Water | 72.25 | 0.007225 | 0.036125 | 0.07225 | 0.1445 | 0.36125 |
| Total % H₂O₂ sol'n | | 0.25 | 1.19 | 2.27 | 4.17 | 8.33 |
| Total % H₂O₂ | | 0.087 | 0.417 | 0.795 | 1.46 | 2.92 |
| Abrasive Customization | | | | | | |
| Agent | | | | | | |
| Zeodent 109 | 40.00 | 0.004 | 0.02 | 0.04 | 0.08 | 0.2 |
| Glycerin | 10.00 | 0.001 | 0.005 | 0.01 | 0.02 | 0.05 |
| CMC 7LF | 1.00 | 0.0001 | 0.0005 | 0.001 | 0.002 | 0.005 |
| Water | 49.00 | 0.0049 | 0.0245 | 0.049 | 0.098 | 0.245 |
| Total % Abrasive | | 15.25 | 16.19 | 17.27 | 19.17 | 23.33 |

### Example 3

### Customized Denture Adhesive

A base denture adhesive formulation is customized by adding one or more flavor customizing agent such as shown below. The flavor customizing agent may be supplied in unit dose amounts of about 0.0005 gm to about 0.005 gm for adding to a unit amount of from about 0.5 to about 1.5 gm of base denture adhesive. Alternatively, the flavor customizing agent may be formulated in a form suitable for dispensing onto a strip of denture adhesive base, such as a spray.

| | % | % | % | % | % |
|---|---|---|---|---|---|
| BASE FORMULA | | | | | |
| Methyl Vinyl Ether - Maleic Acid | 33.00 | | | | |
| Copolymer Ca/Zn Salt | | | | | |
| Sodium Carboxy Methyl Cellulose | 20.00 | | | | |
| Mineral Oil | 23.95 | | | | |
| Petrolatum | 21.91 | | | | |
| Colloidal Silica | 1.14 | | | | |
| CUSTOMIZATION AGENT | | | | | |
| Peppermint Oil | 100 | | | | 20 |
| Menthyl Lactate | | 100 | | | 20 |
| Menthol | | | 100 | | 20 |
| Sacharrin | | | | 100 | 1 |
| Mineral Oil | | | | | 39 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of customizing oral care products for consumers, comprising providing the consumer with
a) a base oral care product, and
b) one or more customization agents comprising a component capable of enhancing or modifying one or more performance and/or aesthetic attributes of the base oral care product,
wherein the customization agent is physically and chemically compatible with the base oral care product, such that the consumer may combine one or more customization agents with the base oral care product to make a customized oral care product that delivers the consumer selected oral care benefit(s) and/or use experience(s).

2. A method according to claim 1, wherein the base oral care product is selected from dentifrice, mouthrinse, dental floss, interproximal device, tooth whitening or bleaching product and a denture care product.

3. A method according to claim 1, wherein the customization agent comprises a component selected from oral care actives; flavors; coolants; sweeteners; materials affecting taste, mouthfeel, smell or other sensation; materials affecting color, texture, rheology or appearance; and combinations thereof.

4. A method according to claim 1, further comprising providing the consumer with instructions for combining the customization agent and the base oral care product, wherein said instructions direct the consumer to combine specified amounts of customization agent and base oral care product such that the resulting customized product delivers the desired oral care benefit(s) and use experience.

5. A method according to claim 1, wherein the consumer combines one or more customization agents and base oral care product at the point of use.

6. A customizable oral care product comprising
a) a base oral care product and
b) one or a plurality of customization agents comprising a component capable of enhancing or modifying one or more performance and/or aesthetic attributes of the base oral care product
wherein the customization agent is physically and chemically compatible with the base oral care product allowing the consumer to combine one or more customization agents with the base oral care product to make a customized oral care product that delivers the consumer selected oral care benefit(s) and/or use experience(s).

7. A customizable oral care product according to claim 6, wherein the base oral care product is selected from dentifrice, mouthrinse, dental floss, interproximal device, tooth whitening or bleaching product and a denture care product.

8. A customizable oral care product according to claim 6, wherein the customization agent comprises a component selected from oral care actives; flavors; coolants; sweeteners; materials affecting taste, mouthfeel, smell or other sensation; materials affecting color, texture, rheology or appearance; and combinations thereof.

9. A mouthrinse product directly customizable by a consumer, comprising
a) a base mouthrinse product comprising a liquid carrier capable of further solubilizing, emulsifying or mixing with one or more additional oral care components, and
b) one or a plurality of customization agents comprising a component selected from oral care actives, flavors, coolants, sweeteners, materials affecting taste, mouthfeel, smell or other sensation; materials affecting color, texture, rheology or appearance; and combinations thereof,
wherein one or more of said customization agents is selected by the consumer to combine with the base mouthrinse product to make a customized mouthrinse that delivers the consumer selected oral care benefit(s) and/or use experience(s).

10. A dentifrice product directly customizable by a consumer, comprising
a) a base dentifrice product suitable for use with a toothbrush for cleaning teeth and oral cavity, and
b) one or a plurality of customization agents comprising a component selected from oral care actives, flavors, coolants, sweeteners, materials affecting taste, mouthfeel, smell or other sensation; materials affecting color, texture, rheology or appearance; and combinations thereof,
wherein one or more of said customization agents is selected by the consumer to combine with the base dentifrice product to make a customized dentifrice that delivers the consumer selected oral care benefit(s) and/or use experience(s).

11. A dental floss or interproximal device directly customizable by a consumer, comprising
a) a dental floss or interproximal device suitable for use to clean between teeth, interproximal areas and gumline, and
b) one or a plurality of customization agents comprising a component selected from oral care actives, flavors, coolants, sweeteners, materials affecting taste, mouthfeel, smell or other sensation; materials affecting color, texture, rheology or appearance; and combinations thereof,
wherein one or more of said customization agents is selected by the consumer to coat the dental floss or interproximal device to make a customized dental floss or interproximal device that delivers the consumer selected oral care benefit(s) and/or use experience(s).

12. A customizable oral care product according to claim 6, wherein the customization agent is in a form selected from pastes, gels, liquids, particles, flakes, crystals, powders, agglomerates, beads, strips, fibers, films, tablets or capsules.

13. A customization agent for a mouthrinse product, comprising a component selected from oral care actives, flavors, coolants, sweeteners, materials affecting taste, mouthfeel, smell or other sensation; materials affecting color, texture, rheology or appearance and combinations thereof, wherein the customization agent is packaged in a disposable container suitable for metering an appropriate amount of a base mouthrinse to mix or blend with the customization agent to make a custom mouthrinse having the consumer selected performance and aesthetic attributes.

14. A customization agent for a dentifrice product, comprising a component selected from oral care actives, flavors, coolants, sweeteners, materials affecting taste, mouthfeel, smell or other sensation; materials affecting color, texture, rheology or appearance, wherein the customization agent is in the form of a paste or gel for dispensing as an additional strip along with a strip of a base dentifrice product onto a toothbrush.

15. A kit for customizing an oral care product directly by a consumer, comprising
a) one or a plurality of base oral care products selected from dentifrice, mouthrinse, dental floss, interproximal device, tooth whitening or bleaching product, denture care product;
b) one or a plurality of customization agents that are physically and chemically compatible with the base oral care product(s) and capable of enhancing or modifying performance and aesthetic attributes of the base oral care product(s); and
c) instructions for selecting one or more customization agents to combine with a base oral care product to make a customized product that delivers the oral care benefit(s) and/or use experience(s) desired by the consumer.

16. A kit according to claim 15, wherein the customization agent comprises a component selected from oral care actives; flavors; coolants; sweeteners; materials affecting taste, mouthfeel, smell or other sensation; materials affecting color, texture, rheology or appearance; and combinations thereof.
